(19) United States
(12) Patent Application Publication
(10) Pub. No.: US 2007/0057993 A1
(43) Pub. Date: Mar. 15, 2007

(54) Ink cartridge assembly and inkjet image forming apparatus having the same

(75) Inventors: Karp-sik Youn, Hwaseong-si (KR); Heon-soo Park, Seongnam-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/507,499

(22) Filed: Aug. 22, 2006

(30) Foreign Application Priority Data
Sep. 12, 2005 (KR) 2005-84647

(51) Int. Cl. B41J 2/015

(52) U.S. Cl. 347/40; 347/20

(57) ABSTRACT

An ink cartridge assembly and an inkjet image forming apparatus having the same include a first ink cartridge and a second ink cartridge. The first ink cartridge has a shuttle type printhead to eject ink to form an image on a printing medium while reciprocating to the width direction of the printing medium at a printing position, and the second ink cartridge has an array type printhead to eject ink to form the image on the printing medium at the printing position in a stationary state. The first and second ink cartridges share the printing position. When the second ink cartridge is positioned on the printing position, the first ink cartridge is positioned at the first escape position and when the first ink cartridge is positioned on the printing position, the second ink cartridge is positioned at the second escape position away from the printing position and the first escape position.

### CROSS-REFERENCE TO RELATED APPLICATIONS

This application claims priority under 35 U.S.C. §119(a) from Korean Patent Application No. 10-2005-0084647, filed on Sep. 12, 2005, in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to an image forming apparatus having both a shuttle type printhead and an array type printhead.

2. Description of the Related Art

An image forming apparatus is an apparatus ejecting ink onto paper through nozzles formed on a printhead to form an image. The image forming apparatus is classified as an image forming apparatus having a shuttle type printhead ejecting ink onto the paper while performing a reciprocating motion across a width direction of the paper, and an image forming apparatus having an array type printhead that extends in the width direction of the paper and ejects ink in a stationary state to form the image. The array type printhead has an advantage of a high-speed printing compared to the shuttle type printhead, but has a disadvantage in that a resolution thereof is fixed by an interval between adjacent nozzles formed on the array printhead and thus the array printhead is inappropriate for a high-resolution printing such as a photo.

To solve above problems, an inkjet image forming apparatus having both the shuttle type printhead and the array type printhead has been developed. FIG. 1 is a view illustrating a conventional inkjet image forming apparatus 10.

Referring to FIG. 1, the conventional image forming apparatus 10 includes a first ink cartridge 11 having a shuttle type printhead 12, a second ink cartridge 15 having an array type printhead 16, and a platen 20 spaced a predetermined interval from the shuttle type printhead 12 and the array type printhead 16 and positioned therebelow. Paper S stacked in a paper-supply cassette 22 passes between the platen 20 and the shuttle type printhead 12 or the array type printhead 16 and is stacked on a paper-discharging tray 24. When the inkjet image forming apparatus 10 is set to a general resolution mode, the array type printhead 16 ejects ink onto the paper S to print an image of relatively low resolution in high speed. On the other hand, when the inkjet image forming apparatus 10 is set to a high resolution mode, the shuttle type printhead 12 ejects ink onto paper S to print an image of relatively high resolution in low speed.

In the conventional inkjet image forming apparatus 10 of FIG. 1, the first and second ink cartridges 11 and 15 are provided one after another in a direction that the paper S travels. Accordingly, since a length A1 of an interval through which paper S passes the ink cartridges 11 and 15 is long, it is difficult to manufacture a small-sized image forming apparatus. Also, before ink ejected from the shuttle type printhead 12 is absorbed sufficiently in paper S, the ink spreads due to contact with the array type printhead 16 and thus a printing defect such as smearing can occur.

### SUMMARY OF THE INVENTION

The present general inventive concept provides an ink cartridge assembly and an inkjet image forming apparatus having the same in which a first ink cartridge having a shuttle type printhead and a second ink cartridge having an array type printhead share a printing position and when one of the ink cartridges is positioned on the printing position, the other ink cartridge is moved from the printing position and is positioned in a different position.

The present general inventive concept also provides an ink cartridge assembly and an image forming apparatus having the same to move one of a shuttle type printhead and an array type printhead between a printing position and a non-printing position to avoid a printing defect.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an ink cartridge assembly including a first ink cartridge having a shuttle type printhead that ejects ink onto a printing medium to print an image as the shuttle type printhead moves in a reciprocating motion in a width direction of the printing medium at a printing position, and a second ink cartridge having an array type printhead that extends in the width direction of the printing medium and ejects the ink to form the image on the printing medium at the printing position in a stationary state, wherein the first and second ink cartridges share the same printing position and when the second ink cartridge is positioned in the printing position, the first ink cartridge is positioned at a first escape position away from the printing position and when the first ink cartridge is positioned in the printing position, the second ink cartridge is positioned at a second escape position away from the printing position and the first escape position.

The first escape position may be provided next to the printing position.

The second escape position may be provided above the printing position.

The ink cartridge assembly may further include a first maintenance device and a second maintenance device to perform maintenance operations on the first and second ink cartridges, respectively, disposed at the first and second escape positions, respectively.

The first maintenance device may include a first cap to cover the shuttle type printhead such that the shuttle type printhead is not exposed, and a first wiper to wipe out ink drops on the shuttle type printhead, and the second maintenance device may include a second cap to cover the array type printhead such that the array type printhead is not exposed, and a second wiper to wipe out ink drops on the array type printhead.

The ink cartridge assembly may further include an element reciprocating the first ink cartridge within the printing position and moving the first ink cartridge to the printing position and the first escape position, and the element may include a first conveyor belt connected with the first ink cartridge and a plurality of wheels that movably supports the first conveyor belt.

The ink cartridge assembly may further include an element moving the second ink cartridge to the printing position and the second escape position, and the element may include a second conveyor belt connected with the second ink cartridge and a plurality of wheels that movably supports the second conveyor belt.

The foregoing and/or other aspects and utilities of the present general inventive concept may also be achieved by providing an image forming apparatus, including a platen, a first printhead to move between a first printing position and a first rest position and to form a paper path with the platen when being in the first printing position, and a second printhead to move between a second printing position and a second rest position and to form a second paper path with the platen when being in the second printing position.

The foregoing and/or other aspects and utilities of the present general inventive concept may also be achieved by providing a method of printing with two image qualities for an image forming apparatus, the method including moving a first printhead between a printing position and a first position, printing a first print when the first printhead is in the printing position, moving a second printhead between the printing position and a second position, and printing a second print when in the second printhead is in the printing position.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an exemplary sectional view illustrating a conventional inkjet image forming apparatus according to the prior art;

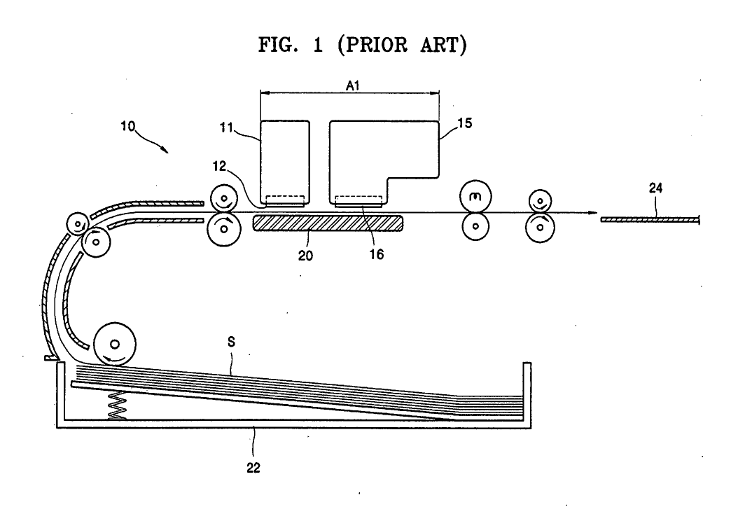

FIG. 2 is a sectional view illustrating an inkjet image forming apparatus according to an embodiment of the present general inventive concept;

FIG. 3 is a perspective view illustrating the ink cartridge assembly of FIG. 2;

FIG. 4 is a perspective view illustrating a first ink cartridge moved to a printing position in the ink cartridge assembly of FIG. 2; and

FIG. 5 is a perspective view illustrating a second ink cartridge moved to a printing position in the ink cartridge assembly of FIG. 2.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

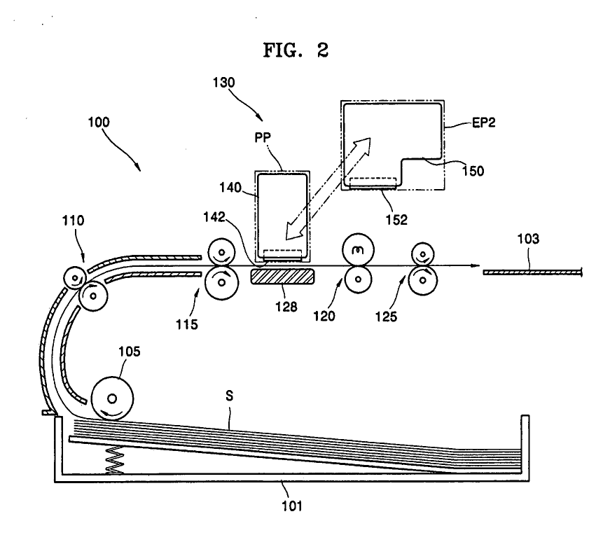

FIG. 2 is a sectional view illustrating an inkjet image forming apparatus according to an embodiment of the present general inventive concept.

Referring to FIG. 2, the inkjet image forming apparatus 100 includes an ink cartridge assembly 130 to eject ink onto a printing medium, such as one or more sheets of paper S to form an image, and a paper-delivery unit to deliver the paper S so that the paper S may pass a printing position PP. The paper-delivery unit includes delivery rollers 110 to deliver the paper S so that the paper S may pass the printing position PP, and discharge rollers 125 to discharge the paper S on which the image is formed by ink ejection to a paper-discharging tray 103. The delivery rollers 110 and the discharge rollers 125 each include a drive roller and a driven roller installed to press each other such that paper S may progress through a contact surface formed by a pair of rollers that face each other. Registration rollers 115 align the paper S so that the ink cartridge assembly 130 can form the image on a desired portion of the paper S.

The inkjet image forming apparatus 100 includes a paper-supply cassette 101 in which the paper S is stacked and a pick-up roller 105 to pick up the paper S stacked in the paper-supply cassette 101 sheet by sheet. Also, the inkjet image forming apparatus 100 may include a dryer 120 to dry the image formed on the paper S. Since the inkjet image forming apparatus 100 having an array type printhead 152 has a fast printing speed, the paper S is not dried sufficiently and is continuously stacked in the paper-discharging tray 103, which may cause spread of ink. Accordingly, the dryer 120 dries an image quickly to prevent a printing defect due to a spreading or smearing of the ink.

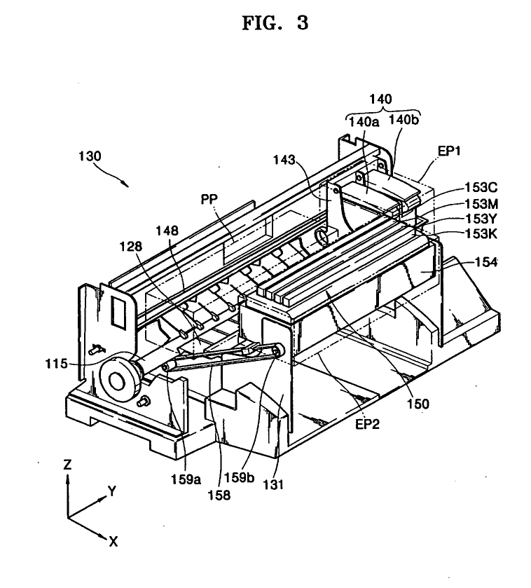

The ink cartridge assembly 130 includes a first ink cartridge 140 having a shuttle type printhead 142 that ejects ink onto the paper S to print the image while performing a reciprocating motion in the a width direction (a Y-axis direction illustrated in FIG. 3) of the paper S and a second ink cartridge 150 having the array type printhead 152 that extends in the width direction of the paper S and ejects ink to print an image on paper S at the printing position PP in a stationary state. When the first ink cartridge 140 is positioned at the printing position PP, the second ink cartridge 150 may be positioned at a second escape position EP2 in FIG. 2, the second ink cartridge 150 is positioned at the printing position PP, the first ink cartridge 140 may be positioned at a first escape position EP1 (refer to FIG. 3) according to a second printing mode.

A platen 128 to support the paper S that passes below the first ink cartridge 140 or the second ink cartridge 150 positioned at the printing position PP is disposed below the printing position PP The platen 128 maintains a constant interval between the paper S and a lower surface of the shuttle type printhead 142 or the array type printhead 152 to prevent a deterioration in an image quality.

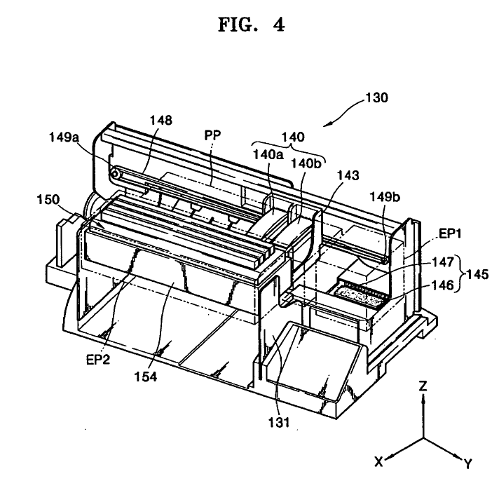

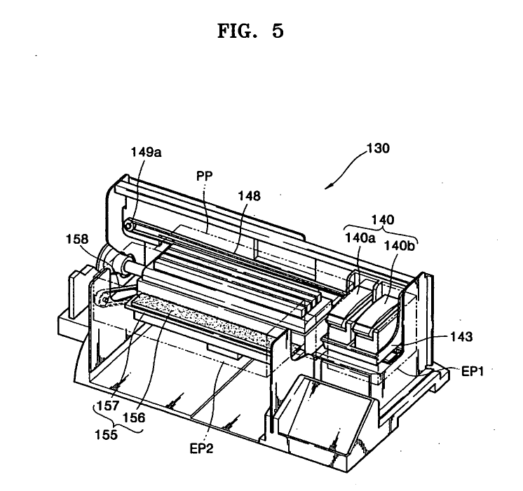

FIG. 3 is a perspective view illustrating the ink cartridge assembly of FIG. 2, and FIGS. 4 and 5 are perspective views illustrating the ink cartridge assembly of FIG. 2, as viewed from a different direction. The platen 128 forms a paper path “P” with either one of the shuttle type printhead 142 and the array type printhead 152 in the printing position PP. The paper path P may be extended to the pickup roller 105 and/or the discharge rollers 125. FIG. 4 is a perspective view illustrating the first ink cartridge 140 moved to the printing position PP and FIG. 5 is a perspective view illustrating the second ink cartridge 150 moved to the printing position PP.

Referring to FIG. 3, the first ink cartridge 140 includes a mono cartridge 140a to eject ink of a black color K and a color cartridge 140b to eject ink of cyan C, magenta M, and yellow Y colors. Though not shown, the mono cartridge 140a has an ink tank to store the black ink K and a negative pressure regulator (not illustrated) therein, and the color cartridge 140b has three ink tanks to store the ink of cyan C, magenta M, and yellow Y colors, and three negative pressure regulators (not illustrated). Also, the mono cartridge 140a and the color cartridge 140b have the shuttle type printhead 142 (refer to FIG. 2). The negative pressure regulator regulates the negative pressure of ink flowing from the ink tank into the shuttle type printhead 142 to prevent air bubbles from flowing into the shuttle type printhead 142 or prevent ink from leaking out through nozzles (not shown). The mono cartridge 140a and the color cartridge 140b are mounted in a first carrier 143. The color cartridge 140b, however, may have any number of colors and pressure regulators. When the inkjet image forming apparatus is a mono image forming apparatus, it is possible that the ink cartridge assembly 130 includes either the mono cartridge 140a or the color cartridge 140b in the first cartridge 140.

The first ink cartridge 140 is mounted on a frame 131 within the inkjet image forming apparatus 100 to reciprocate in the Y-axis direction, which is the width direction of the paper S. A first conveyor belt 148 to reciprocate the first ink cartridge 140 in the Y-axis direction is included in the image forming apparatus 100. The first conveyor belt 148 is movably supported by first and second wheels 149a and 149b (refer to FIG. 4) and are arranged in the Y-axis direction. The first carrier 143 is fixedly attached on one side of the first conveyor belt 148, so that the first ink cartridge 140 moves to a positive (+) direction or a negative (−) direction of the Y-axis as the first conveyor belt 148 travels. One of either the first wheel 149a and the second wheel 149b is connected with a motor (not shown) to serve as a drive wheel that drives the first conveyor belt 148 and the other wheel serves as a driven wheel that is rotated as the first conveyor belt 148 travels. The first ink cartridge 140 can move from the first escape position EP1 to the printing position PP, or from the printing position PP to the first escape position EP1 along the travel direction of the first conveyor belt 148. The printing position PP and the first escape position EP1 are disposed in the Y-direction, such as the width direction of the paper P

When the inkjet image forming apparatus 100 (refer to FIG. 2) is set to a high-resolution mode, the first ink cartridge 140 ejects ink onto the paper S while performing a reciprocating motion along the Y-axis direction at the printing position PP as illustrated in FIG. 4. On the contrary, when the image forming apparatus 100 is set to a general resolution mode, the first ink cartridge 140 is moved to and positioned at the first escaping position EP1 prepared next to the printing position PP, as illustrated in FIG. 5.

Referring to FIG. 4, the first maintenance device 145 to perform a maintenance operation on the first ink cartridge 140 is prepared at the first escape position EP1. The maintenance operation is an operation performed during an interval between ink ejections. For example, the maintenance operation may include a spitting operation that ejects a small amount of ink so as to prevent nozzles from being blocked due to a foreign substance or a drying of the ink, a wiper that wipes away ink drops on the lower surface of the shuttle type printhead 142 so that the ejection direction of the ink may not be distorted, and a cap that covers the shuttle type printhead 142 so that the shuttle type printhead 142 is not exposed to an outside environment.

The first maintenance device 145 includes a first cap 147 to cover the shuttle type printhead 142 (refer to FIG. 2) so that the shuttle type printhead 142 is not exposed and to suppress an inflow of foreign substances or the drying of the ink, and a first wiper 146 to wipe out ink on a surface of the shuttle type printhead 142. When the first ink cartridge 140 stops at the first escape position EP1, the shuttle type printhead 142 is covered with the first cap 147. In the covered state, a spitting operation is performed and then a wiping operation is performed by a contact between the shuttle type printhead 142 and the first wiper 146 while the first ink cartridge 140 moves from the first escape position EP1 to the printing position PP. The first escape position EP1 may include a first sub-position in which the first ink cartridge 140 is disposed to perform the maintenance operation on the first ink cartridge 140 disposed in the first sub-position. The second sub-position is disposed below the first sub-position. The first cap 147 and the first wiper 146 moves according to the maintenance operation.

Referring to FIG. 3, the second ink cartridge 150 has four ink tanks 153C, 153M, 153Y, and 153K to store the ink having colors of cyan C, magenta M, yellow Y, and black K, respectively, four negative pressure regulators (not shown), and an array type printhead 152 (refer to FIG. 2) in the inside. The negative pressure regulator (not shown) regulates the negative pressure flowing from the four ink tanks 153C, 153M, 153Y, and 153K to the array type printhead 152 to prevent air bubbles from flowing into the array type printhead 152 and to prevent ink from leaking out through the nozzles (not shown). The second ink cartridge is mounted in the second carrier 154.

The second ink cartridge 150 shares the printing position PP with the first ink cartridge 140. When the inkjet image forming apparatus 100 is set to a general resolution mode, the second ink cartridge 150 ejects ink to print the image on the paper S at the printing position PP in a stationary state as illustrated in FIG. 5. At this point, the first ink cartridge 140 is positioned at the first escape position EP1 as described above. When the image forming apparatus 100 is set to a high-resolution mode, the first ink cartridge 140 ejects the ink to form the image while reciprocating in the Y-axis direction within the printing position PP and the second ink cartridge 150 is moved to the second escape position EP2 and positioned thereon as illustrated in FIG. 4. The second escape position EP2 is located in an inclined direction above the printing position PP. Therefore, the dryer 120 and the discharge rollers 125 can be disposed adjacent to the printing position PP below the second escape position EP2, so that a size, particularly a length of the image forming apparatus 100 can be reduced.

An element that moves the second cartridge 150 from the printing position PP to the second escape position EP2, or from the second escape position EP2 to the printing position PP includes the second conveyor belt 158 and the first and second wheels 159a and 159brotatably mounted at a frame 131 to movably support the second conveyor belt 158. The second carrier 154 is fixedly attached on one side of the second conveyor belt 158, so that the second ink cartridge 150 moves to the printing position PP or the second escape position EP2 as the second conveyor belt 158 travels.

One of either the first wheel 159a and the second wheel 159b is connected with a motor (not shown) to serve as a drive wheel that drives the second conveyor belt 158 and the other wheel serves as a driven wheel that is rotated as the second conveyor belt 158 travels.

Referring to FIG. 5, a second maintenance device 155 to perform a maintenance operation on the second ink cartridge 150 is prepared at the second escape position EP2.

The second maintenance device 155 includes a second cap 157 to cover the array type printhead 152 (refer to FIG. 2) so that the array type printhead 152 is not exposed to the outside and to suppress the inflow of foreign substance and/or the drying of the ink, and a second wiper 156 to wipe out ink on a surface of the array type printhead 152. When the second ink cartridge 150 stops at the second escape position EP2, the array type printhead 152 is covered with the second cap 157. While in the covered state, a spitting operation is performed and then a wiping operation is performed by a contact between the array type printhead 152 and the second wiper 156 while the second ink cartridge 150 moves from the second escape position EP2 to the printing position PP. The second maintenance device 153 is disposed adjacent to the second escape position EP2 to perform the maintenance operation on the second ink cartridge 150. The second cap 157 and the second wiper 156 moves according to the maintenance operation.

As described above, an ink cartridge assembly and an inkjet image forming apparatus of the present general inventive concept having the same can print an image of high resolution (e.g., a photo), though in a low speed, using a first ink cartridge that has a shuttle type printhead thereon, and an image having a general resolution in high speed, using a second ink cartridge that has a an array type printhead thereon.

As described above, since first and second ink cartridges share a printing position, a size, particularly a length of an image forming apparatus can be reduced.

As described above, when one ink cartridge is positioned at a printing position, an other ink cartridge is out of a progression path of paper, so that a printing defect such as smearing is prevented.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An ink cartridge assembly, comprising:
a first ink cartridge having a shuttle type printhead that ejects ink onto a paper to form an image as the shuttle type printhead moves in a reciprocating motion in a width direction of the printing medium at a printing position; and
a second ink cartridge having an array type printhead that extends in the width direction of the printing medium and discharges the ink to form the image on the printing medium at the printing position in a stationary state,
wherein the first and second ink cartridges share the same printing position and when the second ink cartridge is positioned in the printing position, the first ink cartridge is positioned at a first escape position away from the printing position and when the first ink cartridge is positioned in the printing position, the second ink cartridge is positioned at a second escape position away from the printing position and the first escape position.

2. The assembly of claim 1, wherein the first escape position is provided next to the printing position.

3. The assembly of claim 1, wherein the second escape position is provided above the printing position.

4. The assembly of claim 1, further comprising:
a first maintenance device and a second maintenance device disposed at the first and second escape positions to perform maintenance operations on the first and second ink cartridges, respectively.

5. The assembly of claim 4, wherein the first maintenance device comprises a first cap to cover the shuttle type printhead such that the shuttle type printhead is not exposed, and a first wiper to wipe out ink drops on the shuttle type printhead, and the second maintenance device comprises a second cap to cover the array type printhead such that the array type printhead is not exposed, and a second wiper to wipe out ink drops on the array type printhead.

6. The assembly of claim 1, further comprising:
an element to reciprocate the first ink cartridge within the printing position and to move the first ink cartridge to the printing position and the first escape position,
wherein the element comprises a first conveyor belt connected with the first ink cartridge and a plurality of wheels that movably support the first conveyor belt.

7. The assembly of claim 1, further comprising:
an element to move the second ink cartridge to the printing position and the second escape position,
wherein the element comprises a second conveyor belt connected with the second ink cartridge and a plurality of wheels that movably support the second conveyor belt.

8. An image forming apparatus, comprising:
an ink cartridge assembly having a first ink cartridge having a shuttle type printhead that ejects ink onto a printing medium to print an image as the shuttle type printhead moves in a reciprocating motion in a width direction of the printing medium at a printing position, and a second ink cartridge having an array type printhead that extends in the width direction of the printing medium and ejects the ink to print the image on the printing medium at the printing position in a stationary state; and
a printing medium-delivery unit to deliver the printing medium so that the printing medium passes through the printing position,
wherein the first and second ink cartridges share the same printing position and when the second ink cartridge is positioned in the printing position, the first ink cartridge is positioned at a first escape position away from the printing position and when the first ink cartridge is positioned in the printing position, the second ink cartridge is positioned at a second escape position away from the printing position and the first escape position.

9. The apparatus of claim 8, wherein the first escape position is provided next to the printing position.

10. The apparatus of claim 8, wherein the second escape position is provided above the printing position.

11. The apparatus of claim 8, wherein a first maintenance device and a second maintenance device disposed at the first and second escape positions to perform maintenance operations on the first and second ink cartridges.

12. The apparatus of claim 11, wherein the first maintenance device comprises a first cap to cover the shuttle type printhead such that the shuttle type printhead is not exposed, and a first wiper to wipe out ink drops on the shuttle type printhead, and the second maintenance device comprises a second cap to cover the array type printhead such that the array type printhead is not exposed, and a second wiper to wipe out ink drops on the array type printhead.

13. The apparatus of claim 8, further comprising an element to reciprocate the first ink cartridge within the printing position and to move the first ink cartridge to the printing position and the first escape position,
wherein the element comprises a first conveyor belt connected with the first ink cartridge, and a plurality of wheels that movably support the first conveyor belt.

14. The apparatus of claim 8, further comprising an element to move the second ink cartridge to the printing position and the second escape position,
wherein the element comprises a second conveyor belt connected with the second ink cartridge and a plurality of wheels that movably support the second conveyor belt.

15. An image forming apparatus, comprising:
a platen;
a first printhead to move between a first printing position and a first rest position and to form a paper path with the platen when being in the first printing position; and
a second printhead to move between a second printing position and a second rest position and to form a second paper path with the platen when being in the second printing position.

16. The image forming apparatus of claim 15, wherein the first printhead has a first length in a moving direction thereof, and the second printhead a second length longer than the first length.

17. The image forming apparatus of claim 15, further comprising:
a frame; and
a convey unit mounted on the frame to reciprocate the first printhead within the first printing position to perform printing.

18. The image forming apparatus of claim 17, wherein the convey unit is extended from the first printing position to the first rest position in the reciprocating direction.

19. The image forming apparatus of claim 17, wherein the convey unit to move first print head between the first printing position and the first rest position.

20. The image forming apparatus of claim 17, further comprising a second convey unit mounted on the frame to move the second printhead between the second printing position and the rest position.

21. The image forming apparatus of claim 20, wherein the second convey unit is extended in a direction with respect to a paper convey direction.

22. The image forming apparatus of claim 15, wherein:
the first printhead comprises a mono cartridge and a color cartridge, and the second print head comprises a plurality of color tanks extended in a lengthwise direction.

23. The image forming apparatus of claim 15, wherein the first printing position and the second printing position are the same position to form the paper path with the platen.

24. The image forming apparatus of claim 15, further comprising:
a first maintenance unit disposed adjacent to the first rest position; and
a second maintenance unit disposed adjacent to the second rest position.

25. The image forming apparatus of claim 15, wherein the first printhead is one of either an array type printhead or a shuttle type printhead and the second printhead is one of the other of the array type printhead or the shuttle type printhead.

26. The image forming apparatus of claim 15, wherein the first position and the printing position are disposed in a direction perpendicular to a printing medium travel direction.

27. The image forming apparatus of claim 15, wherein the second position is provided in a direction from the printing position in a direction having an angle with a printing medium travel direction.

28. The image forming apparatus of claim 15, wherein the first printhead and the second printhead are alternately disposed in the printing position while the other printhead is positioned in either the first or second position, respectively.

29. A method of printing with two image qualities for an image forming apparatus, the method comprising:
moving a first printhead between a printing position and a first position;
printing with a first print quality when the first printhead is in the printing position;
moving a second printhead between the printing position and a second position; and
printing with a second print quality when the second printhead is in the printing position.

30. The method of claim 29, further comprising:
delivering paper to an area below the printing position for either of the first or second printhead to print thereon,
wherein the first print head comprises an array type printhead and the second printhead comprises a shuttle type printhead.

31. The method of claim 29, wherein the first position and the printing position are disposed perpendicular to a paper travel direction.

32. The method of claim 29, wherein the second position and the printing position are disposed parallel to a paper travel direction.

33. The method of claim 29, wherein the second position is provided in a direction above the printing position in a direction perpendicular to a paper travel direction.
